(19) United States
(12) Patent Application Publication
(10) Pub. No.: US 2011/0169752 A1
(43) Pub. Date: Jul. 14, 2011

(54) INPUT DEVICE AND RECORDING MEDIUM STORING INPUT CONTROL PROGRAM

(75) Inventor: Masaaki Wakizaka, Ichinomiya-shi (JP)

(73) Assignee: BROTHER KOGYO KABUSHIKI KAISHA, Nagoya-shi (JP)

(21) Appl. No.: 12/948,334

(22) Filed: Nov. 17, 2010

(30) Foreign Application Priority Data
Jan. 11, 2010 (JP) 2010-003484

(51) Int. Cl. G06F 3/041

(52) U.S. Cl. 345/173

(57) ABSTRACT

An input device includes a touch panel having a detection region and configured, when an operation is made within the detection region, to detect a position in which the operation is made. The detection region includes operation receiving regions located in respective different positions and associated with respective different procedures. The input device further includes an executer configured, when one of the operation receiving regions is operated, to execute one of the procedures with which the operated operation receiving regions is associated; and an operable region expander configured, when the operated operation receiving region is operated in a consecutive manner, to cause an additionally associated region to be additionally associated with the procedure with which the operated operation receiving region is associated. The additionally associated region constitutes at least a part of rest of the detection region, which is other than the operated operation receiving region. Also disclosed is a recording medium storing an input control program that is to be executed in the input device.

### CROSS REFERENCE TO RELATED APPLICATION

This application claims priority from Japanese Patent Application No. 2010-003484 filed on Jan. 11, 2010, the disclosure of which is herein incorporated by reference in its entirety.

### BACKGROUND OF THE INVENTION

1. Field of the Invention

The present invention relates to an input device and a recording medium storing an input control program.

2. Discussion of Related Art

There is known a technique of assuming, when an invalid region that is other than a button region is touched at two consecutive times in a touch panel control device, that a button located between two touched portions of the invalid region has been touched. This assumption technique is purposed for improving an operability in a consecutive operation of the touch panel control device.

### SUMMARY OF THE INVENTION

In an operation of a device equipped with a touch panel, there is a case where a certain key such as up/down keys and right/left keys provided on the touch panel should be pressed or touched repeatedly by an operator. However, if the operator looks away from a display of the touch panel during such a consecutive operation, a position of the touch could be gradually deviated from the certain key, thereby causing a risk that a wrong key could be pressed or touched.

It is therefore an object of the present invention to provide an input device and a recording medium storing an input control program, which are effective for avoiding an operational error, even if a consecutive operation is made without closely watching an operated position.

This object of the invention may be achieved by a first aspect of the invention, which provides an input device including: (a) a touch panel having a detection region and configured, when an operation is made within the detection region, to detect a position in which the operation is made, the detection region including a plurality of operation receiving regions which are located in respective positions different from each other and which are associated with respective procedures different from each other; (b) an executer configured, when one of the operation receiving regions is operated, to execute one of the procedures with which the one of the operation receiving regions is associated; and (c) an operable region expander configured, when the operated one of the operation receiving regions is operated in a consecutive manner, to cause an additionally associated region to be additionally associated with the one of the procedures with which the operated one of the operation receiving regions is associated. The additionally associated region is included in the detection region, and constitutes at least a part of rest of the detection region. The rest of the detection region is other than a consecutively-operated operation receiving region that is the operated one of the operation receiving regions.

The above object of the invention may be achieved by a second aspect of the invention, which provides a recording medium storing an input control program that is to be executed in an input device that is defined in the above-described first aspect of the invention. The input control program includes: an executing step implemented, when one of said operation receiving regions is operated, for executing one of the procedures with which said one of said operation receiving regions is associated; and an operable-region expanding step implemented, when the operated one of said operation receiving regions is operated in a consecutive manner, for causing an additionally associated region to be additionally associated with said one of the procedures with which said operated one of said operation receiving regions is associated. The additionally associated region is included in the detection region, and constitutes at least a part of rest of the detection region. The rest of the detection region is other than a consecutively-operated operation receiving region that is the operated one of the operation receiving regions.

The above-described term “operation in a consecutive manner” may be interpreted as either an intermittent operation in which the above-described one of the operation receiving regions is operated at least twice within a predetermined length of time, or a continuous operation in which the one of the operation receiving regions is operated without interruption for at least a predetermined length of time, although the technical advantage provided by the present invention is more enjoyable where the operation in the consecutive manner is the intermittent operation.

In the above-described input device, the touch panel may be superposed on a display surface, such that the touch panel and the display surface are held in close contact with each other, or are spaced apart from each other with a clearance defined therebetween or a transparent film interposed therebetween.

The principle of the present invention is applicable to various forms such as an input device, an input control device configured to control the input device, an input method using the input device, an input control program configured to control the input device, and a recording medium storing the input control program.

### BRIEF DESCRIPTION OF THE DRAWINGS

The above and other objects, features, advantages and technical and industrial significance of the present invention will be better understood by reading the following detailed description of presently preferred embodiments of the invention, when considered in connection with the accompanying drawings, in which:

FIG. 1 is a block diagram showing an electric arrangement in MFP (multi-function peripheral) constructed according to a first embodiment of the present invention;

FIGS. 2A and 2B are a set of views showing LCD (liquid crystal display) and a touch panel that are included in the MFP, wherein FIG. 2A shows states of a display surface of the LCD and a detection region of the touch panel when the MFP is placed in an ordinary mode, and FIG. 2B shows their states when the MFP is placed in a consecutive mode;

FIG. 3 is a flow chart showing a display updating routine that is carried out in the MFP of the first embodiment;

FIGS. 4A, 4B and 4C are a set of views showing the LCD and the touch panel that are included in the MFP of a second embodiment, wherein FIG. 4A shows states of the display surface of the LCD and the detection region of the touch panel when the MFP is placed in the ordinary mode, FIG. 4B shows their states when the MFP is placed in the consecutive mode, and FIG. 4C shows their states upon termination of the consecutive mode; and

FIG. 5 is a flow chart showing the display updating routine that is carried out in the MFP of the second embodiment.

### DETAILED DESCRIPTION OF THE PREFERRED EMBODIMENTS

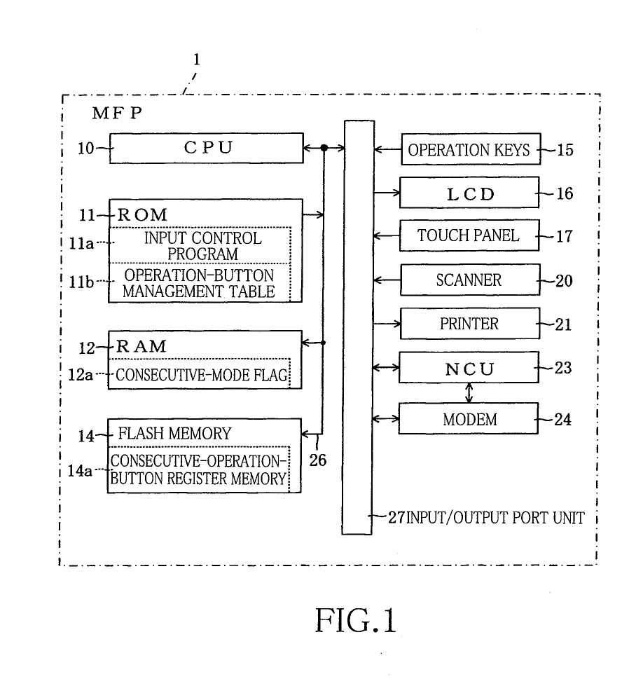

There will be described preferred embodiments of the invention, with reference to the drawings. FIG. 1 is a block diagram showing an electric arrangement in an input device in the form of a multi-function peripheral (hereinafter referred to as “MFP”) 1 that is constructed according to a first embodiment of the invention.

The MFP 1 has various functions such as copy, facsimile, scan and print functions. Particularly, the MFP 1 is arranged to be effective to avoid an operational error without necessity of closely watching a position of operation even during a consecutive operation.

The MFP 1 has CPU 10, ROM 11, RAM 12, a flash memory 14, operation keys 15, LCD (liquid crystal display) 16, a touch panel 17, a scanner 20, a printer 21, NCU (network control unit) 23 and a modem 24. The CPU 10, ROM 11, RAM 12 and flash memory 14 are connected to one another via bus lines 26. Further, the operation keys 15, LCD 16, touch panel 17, scanner 20, printer 21, NCU 23, modem 24 and bus lines 26 are connected to one another via an input/output port unit 27.

The CPU 10 is provided to control the functions of the MFP 1 and the elements connected to the input/output port unit 27, in accordance with fixed values and programs stored in the ROM 11, RAM 12 and flash memory 14 and various signals transmitted via the NCU 23.

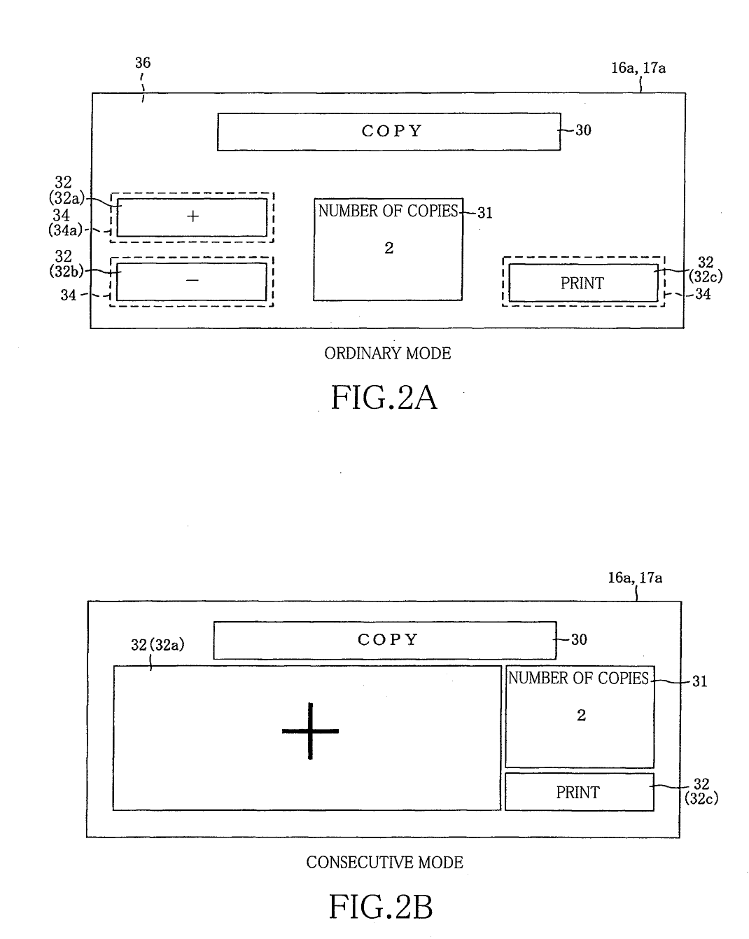

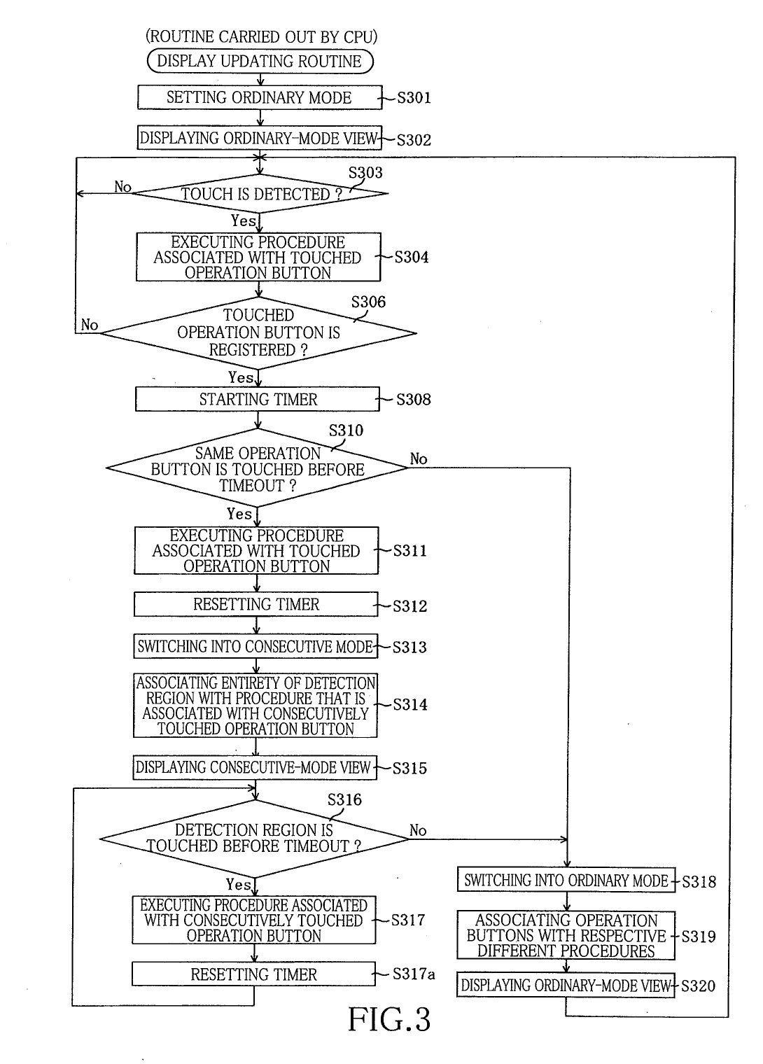

The ROM 11 is a recording medium in the form of an unwritable memory that stores, for example, an input control program 11a and an operation-button management table 11b. The CPU 10 carries out a display updating routine (see FIG. 3) in accordance with the input control program 11a. The operation-button management table 11b is a table storing data indicative of coordinates of operation buttons 34 provided on the touch panel 17 and also data representing correspondence between each of the operation buttons 34 and a corresponding one of procedures with which each operation button 34 is associated. The operation buttons 34 will be described later with reference to FIG. 2.

The RAM 12 is a volatile writable memory, and is provided with a consecutive-mode flag 12a. The CPU 10 is configured, when the consecutive-mode flag 12a is OFF, to judge that the MFP 1 is being placed in an “ordinary mode”, and is configured, when the consecutive-mode flag 12a is ON, to judge that the MFP 1 is being placed in a “consecutive mode”. The “ordinary mode” and “consecutive mode” will be described later with reference to FIG. 2.

The flash memory 14 is a non-volatile writable memory, and is provided with a register in the form of a consecutive-operation-button register memory 14a that is configured to register therein at least one of the operation buttons 34 which is selected by an user of the MFP 1. The MFP 1 is switched from the ordinary mode to the consecutive mode, when any one of the at least one of the operation buttons 34 registered in the consecutive-operation-button register memory 14a is operated in a consecutive manner.

Each of the operation keys 15 is a hard key provided for inputting a command into the MFP 1. The LCD 16 is a liquid crystal display device, and has a display surface 16a (see FIG. 2) on which the touch panel 17 is superposed, so as to display an image on the display surface 16a.

The touch panel 17 is a projection-type electrostatic capacitance touch-panel, and has a detection region 17a (see FIG. 2). The entirety of the detection region 17a is sectioned into small portions in a lattice manner, and electrodes are disposed in the respective small portions each of which corresponds to an unit region. When an input medium (not shown) such as an operator's finger is brought into proximity or contact with the detection region 17a of the touch panel 17, an electrostatic coupling takes place between the input medium and the electrode, thereby causing capacitance change of the electrode. Each unit region within the detection region 17a is associated with data indicative of position of the unit region, which is represented by two values in X-Y coordinate system where its origin corresponds to an upper-left vertex of the detection region 17a while its X and Y directions correspond to rightward and downward directions, respectively, as seen in FIG. 2. The touch panel 17 is configured, when an operation by the input medium is made within the detection region 17a, to detect a position in which the operation is made, and then to output the detected position represented by two values in the X-Y coordinate system. In this instance, the touch panel 17 determines, as the position in which the operation is made, one of the unit regions in which the capacitance change of the electrode is found.

The scanner 20 is configured to read an original copy when the facsimile, scan or copy function is to be performed. The printer 21 is configured to print an image onto a recording sheet. The NCU 23 is configured to control a telephone circuit. The modem 24 is configured, when a signal is to be transmitted via the facsimile function, to modulate the signal into a form suitable for transmission through the telephone circuit, and is configured, when a modulated signal is to be received via the facsimile function, to demodulate the modulated signal transmitted through the telephone circuit.

FIG. 2A is a view showing states of the display surface 16a of the LCD 16 and the detection region 17a of the touch panel 17 when the MFP 1 is placed in the ordinary mode. A view displayed on the display surface 16a during the ordinary mode will be referred hereafter to as “ordinary-mode view”. As shown in FIG. 2A, the ordinary-mode view includes a selected-function information 30 indicating a currently selected one of the functions, a set-value information 31 indicating a set value, and a plurality of button image elements 32.

During the ordinary mode, the plurality of operation buttons 34 as operation receiving regions are disposed in respective different positions within the detection region 17a of the touch panel 17. The coordinate data indicative of positions of the respective operation buttons 34 are prestored in the operation-button management table 11b. In the ordinary mode, the operation buttons 34 are associated with the respective procedures different from each other. The procedures with which the respective operation buttons 34 are to be associated are prestored in the operation-button management table 11b. The term “associating” means determining correspondence between each position or region (within the detection region 17) and a corresponding one of the procedures that is to be executed by the CPU 10 upon operation of the each position or region. It is noted that the rest of the detection region 17a which is other than any one of the operation buttons 34 will be referred to as an operation non-receiving region 36.

During the ordinary mode, when an operation is made within the detection region 17a of the touch panel 17, the touch panel 17 outputs the coordinate data indicative of position in which the operation is made, and the CPU 10 is configured to judge, based on the coordinate data supplied from the touch panel 17, whether the position (in which the operation is made) is included in any one of the operation buttons 34. When it is judged that the position is included in one of the operation buttons 34, the CPU 10 is configured to execute one of the procedures with which the one of the operation buttons 34 is associated.

In FIG. 2A, each of the operation buttons 34 is illustrated by broken line. However, this is merely for convenience of explanation, and each operation button 34 is not displayed on the display surface 16a and is not visually recognizable by the operator. During the ordinary mode, the button image elements 32 representing the respective procedures are displayed such that each of the displayed button image elements 32 representing a corresponding one of the procedures is positioned within one of the operation buttons 34 that is associated with the corresponding one of the procedures. Therefore, the operator, who wishes to execute a desired one of the procedures, can be guided by a corresponding one of the button image element 32, for operating a corresponding one of the operation buttons 34 that is associated with the desired one of the procedure.

In the ordinary-mode view, a plus-button image element 32a, a minus-button image element 32b and a print-button image element 32c are provided as the button image elements 32. The plus-button image element 32a is positioned within one of the operation buttons 34 that is associated with a procedure by which a set value of number of copies is to be increased by “1”. The minus-button image element 32b is positioned within one of the operation buttons 34 that is associated with a procedure by which a set value of number of copies is to be reduced by “1”. The print-button image elements 32c is positioned within one of the operation buttons 34 that is associated with a procedure by which a printing operation is to be executed.

The operator can switch the MFP 1 from the ordinary mode to the consecutive mode, by operating any one of the operation buttons 34 in a consecutive manner. In the present embodiment, the term “operation in a consecutive manner” may be interpreted as an intermittent operation in which the detection region 17a is touched at least twice within a predetermined length of time. In the following description, one of the operation buttons 34 which is operated in a consecutive manner will be referred to as a consecutively-operated operation button 34a. In an example shown in FIG. 2A, one of the operation buttons 34 which is associated with a procedure for increasing the set value of number of copies by “1”, corresponds to the consecutively-operated operation button 34a.

In the MFP 1 during the consecutive mode, an entirety of the detection region 17a is caused to be associated with one of the procedures with which the consecutively-operated operation button 34a as a consecutively-operated operation receiving region is originally associated. For example, when the consecutively-operated operation button 34a (i.e., the above-described one of the operation buttons 34) is operated in a consecutive manner by the operator for the purpose of increasing the set value of the number of copies by two or more, the entirety of the detection region 17a is caused to be associated with the above-described procedure with which the consecutively-operated operation button 34a is originally associated. In other words, in the MFP 1 during the consecutive mode, not only the other operation buttons 34 (associated with respective procedures different from the above-described procedure with which the consecutively-operated operation button 34a is associated during the ordinary mode) but also the operation non-receiving region 36 (not associated with any one of the procedures during the ordinary mode) is caused to be additionally associated with the above-described procedure with which the consecutively-operated operation button 34a is originally associated. That is, the other operation buttons 34 and the operation non-receiving region 36 cooperate to constitute an additionally associated region which constitutes at least a part of rest of the detection region 17a other than the consecutively-operated operation button 34a.

Thus, in the MFP 1 during the consecutive mode, each time the detection region 17a is operated no matter which part of the detection region 17a is operated, the same procedure is executed as when the consecutively-operated operation button 34a is operated. For example, in a case where the MFP 1 has been switched from the ordinary mode to the consecutive mode in a response to a consecutive operation made on one of the operation buttons 34 which is associated with the procedure for increasing the set value of number of copies by “1”, the set value of number of copies is increased by “1” each time the detection region 17a is operated. It is therefore possible to avoid an operational error even if the operator carries out the consecutive operation without closely watching a position of the operation.

FIG. 2B shows an example of a display state of the LCD 16 during the consecutive mode. As shown in FIG. 2B, in the MFP 1 during the consecutive mode, the button image elements 32 are displayed in an extraordinary manner (that is different from an ordinary manner in which the button image elements 32 are displayed during the ordinary mode), for thereby facilitating the operator to visually recognize that the MFP 1 is placed in the consecutive mode. A view displayed on the display surface 16a during the consecutive mode will be referred hereafter to as “consecutive-mode view”.

In the consecutive-mode view in the first embodiment, one of the button image elements 32 which represents the procedure associated with the consecutively-operated operation button 34a is displayed in enlargement. For example, in the example shown in FIG. 2B, the plus-button image element 32a is displayed in enlargement. Thus, when a consecutive operation is made, the operator can see at a glance which one of the procedures is to be executed.

In the consecutive-mode view, the other button image elements 32, which are other than the button image element 32 displayed in enlargement, may be either displayed or not displayed. In the example shown in FIG. 2B, the minus-button image element 32b is not displayed in the consecutive-mode view while the print-button image elements 32c is displayed also in the consecutive-mode view.

When at least a part of the detection region 17a of the touch panel 17 is operated, one of the procedures, with which the consecutively-operated operation receiving region 34a is originally associated, is executed irrespective of kind of the button image element 32 that is positioned in the operated part of the detection region 17a, namely, irrespective of which one of the procedures is represented by the button image element 32 that is positioned in the operated part of the detection region 17a. For example, during the consecutive mode in which the consecutive-mode view as shown in FIG. 2B is displayed on the display surface 16a, even if a part of the detection region 17a in which the print-button image element 32c is positioned is erroneously operated by the operator, the CPU 10 is configured to execute the same procedure as when the consecutively-operated operation button 34a is operated, in place of executing the procedure for a printing operation. That is, some of the button image elements 32 corresponding to invalid ones of the operation buttons 34 are kept displayed. Thus, by keeping such button image elements 32 (corresponding to the invalid operation buttons 34) displayed also in the consecutive mode, the operator can recognize all of the procedures executable in the MFP 1.

During the consecutive mode, when the consecutively-operated operation button 34a is associated with a procedure for changing a set value in accordance with the number of times at which the consecutively-operated operation button 34a is operated, the set-value information 31 indicative of the set value is kept displayed in the MFP 1. For example, when the MFP 1 is switched from the ordinary mode to the consecutive mode in a response to a consecutive operation made on the operation button 34 that is associated with the procedure for increasing the set value of number of copies by “1”, the set value of number of copies is represented as the set-value information 31, as shown in FIG. 2B. This arrangement facilitates the operator to continue the operation while visually confirming change of the set values which is made by the consecutive operation.

FIG. 3 is a flow chart showing a display updating routine that is carried out in the MFP 1. This display updating routine is carried out for executing, when one of the operation buttons 34 is operated by the operator, one of the procedures with which the operated one of the operation buttons 34 is associated, and also for switching the MFP 1 from the ordinary mode to the consecutive mode when one of the operation buttons 34 is operated in a consecutive manner by the operator. This routine is repeatedly carried out from when a main power of the MFP 1 is ON until when the main power is OFF.

The display updating routine is initiated with step S301 in which the CPU 10 turns the consecutive-mode flag 12a OFF and places the MFP 1 into the ordinary mode. As described above, during the ordinary mode, the operation buttons 34 are associated with the respective different procedures.

Then, in step S302, the CPU 10 causes the ordinary-mode view (see FIG. 2A) to be displayed on the display surface 16a of the LCD 16. Step S302 is followed by step S303 in which the CPU 10 judges whether an operation (touch) made on at least one of the plurality of operation buttons 34 has been detected or not. As long as a negative judgment (NO) is obtained in step S303, step S303 is repeatedly implemented.

On the other hand, when a positive judgment (YES) is obtained in step S303, the control flow goes to step S304 in which the CPU executes the procedure with which the operated one of the operation buttons 34 is associated. Then, in step S306, the CPU 10 judges whether the operated operation button 34 is registered in the consecutive-operation-button register memory 14a or not. When a negative judgment (NO) is obtained in step S306, the control flow goes back to step S303.

On the other hand, when a positive judgment (YES) is obtained in step S306, the control flow goes to step S308 in which the CPU 10 starts a timer. Then, in step S310, the CPU 10 judges whether the same operation button 34 (i.e., the above-described operated operation button 34) has been touched or not before a timeout, namely, before a length of time measured by the timer becomes a predetermined value. That is, in step S310, it is judged whether the same operation button 34 has been operated in a consecutive manner. When a positive judgment (YES) is obtained in step S310, the control flow goes to step S311 in which the CPU 10 executes the procedure with which the operated operation button 34 is associated. Step S311 is followed by step S312 in which the timer started in step S308 is reset and is then restarted.

Then, in step S313, the CPU 10 turns the consecutive-mode flag 12a ON. In step S314, the entirety of the detection region 17a of the touch panel 17 is caused to be associated with the procedure with which the consecutively-operated operation button 34a has been originally associated.

Then, in step S315, the CPU 10 causes the consecutive-mode view (see FIG. 2B) to be displayed on the display surface 16a of the LCD 16. Then, in step S316, the CPU 10 judges whether the detection region 17a of the touch panel 17 has been touched or not before a timeout, namely, before a length of time measured by the timer becomes a predetermined value. When a positive judgment (YES) is obtained in step S316, the control flow goes to step S317 in which the CPU 10 executes the procedure with which the entirety of the detection region 17a of the touch panel 17 is caused to be associated, namely, executes the procedure with which the consecutively-operated operation button 34a is caused to be associated. Step S317 is followed by step S317a in which the timer started in step S312 is reset and is then restarted, and then control flow goes back to step S316. For the operator, it is possible to consecutively execute the same procedure as when the consecutively-operated operation button 34a is operated, by operating any part of the detection region 17a (irrespective of whether the operated part of the detection region 17a is within or outside the consecutively-operated operation button 34a).

When a negative decision (NO) is obtained in step S310, namely, when the above-described same operation button 34 has not been touched within the predetermined value of the length of time during the ordinary mode, the control flow goes to step S318. Further, also when a negative decision (NO) is obtained in step S316, namely, also when any part of the detection region 17a has not been touched within the predetermined value of the length of time after the MFP 1 had been switched from the ordinary mode to the consecutive mode, the control flow goes to step S318. In step S318, the CPU 10 turns the consecutive-mode flag 12a OFF thereby switching the MFP 1 from the consecutive mode to the ordinary mode. Step S318 is followed by step S319 in which the operation buttons 34 are caused to be associated with the respective different procedures in accordance with the data prestored in the operation-button management table 11b and representing the correspondence between each of the operation buttons 34 and a corresponding one of the procedures. In the subsequent step S320, the ordinary-mode view (see FIG. 2A) is displayed on the display surface 16a of the LCD 16. Then, the control flow goes back to step S303.

In the display updating routine as described above, the MFP 1 is switched from the ordinary mode to the consecutive mode on condition that the consecutively-operated operation button 34 is registered in the consecutive-operation-button register memory 14a, so that it is possible to manage the operation buttons 34, with ones of the operation buttons 34 each having a high possibility of being consecutively operated being distinguished from the other of the operation buttons 34 each not having a high possibility of being consecutively operated. That is, at least one of the operation buttons 34 (such as ones of the operation buttons 34 assigned for increasing and reducing the set value) each having a high possibility of being consecutively operated is pre-registered in the consecutive-operation-button register memory 14a, so that the MFP 1 is switched from the ordinary mode to the consecutive mode when the above-described at least one of the operation buttons 34 is consecutively operated, thereby facilitating a consecutive operation during the consecutive mode. On the other hand, the other of the operation buttons 34 (such as one of the operation buttons 34 assigned for executing a printing operation) each not having a high possibility of being consecutively operated is not pre-registered in the consecutive-operation-button register memory 14a, so that the MFP 1 is not switched from the ordinary mode to the consecutive mode even when the above-described other of the operation buttons 34 is consecutively operated, thereby preventing the MFP 1 from being switched from the ordinary mode to the consecutive mode in an unnecessary case.

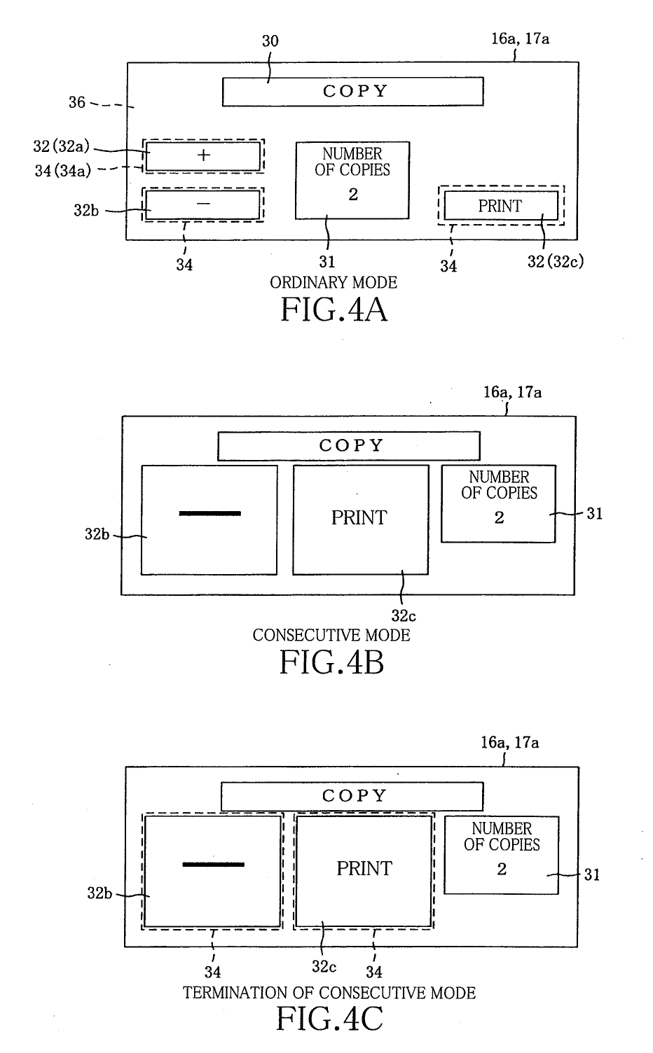

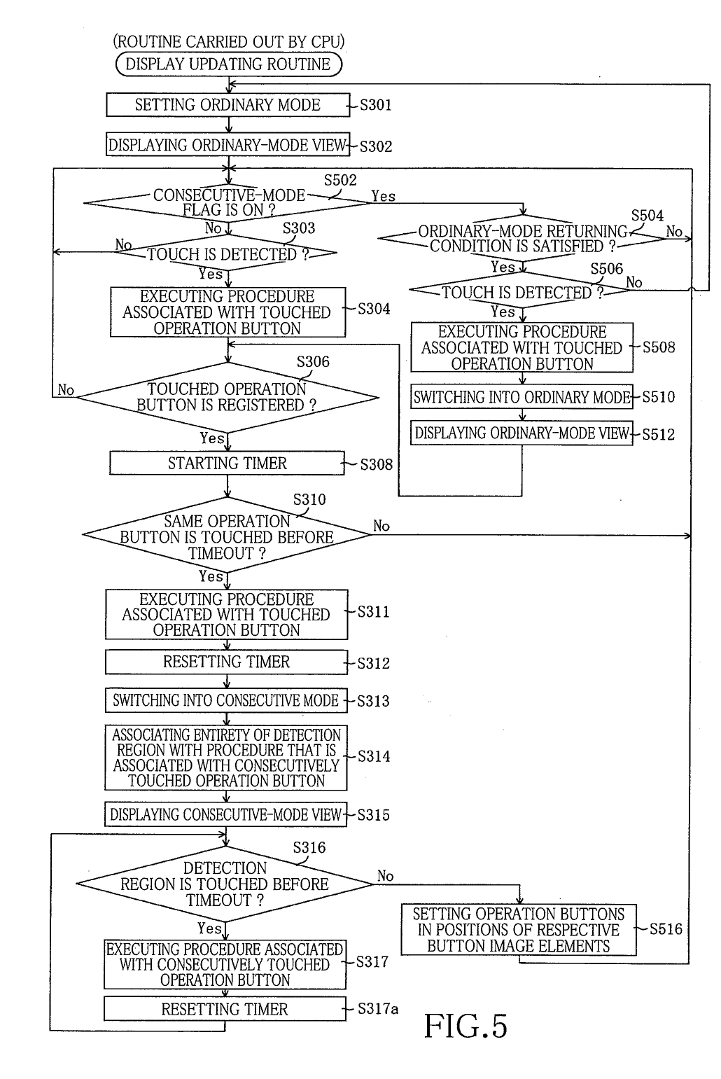

Referring next to FIGS. 4 and 5, there will be described the MFP 1 constructed according to a second embodiment of the invention. The MFP 1 according to this second embodiment is different from the MFP 1 according to the first embodiment with respect to the consecutive-mode view displayed on the display surface 16a during the consecutive mode. In the following description of the second embodiment, the same reference signs as used in the description of the first embodiment are used to identify the same components or elements, which will not be described to avoid redundancy of the description.

FIG. 4A is a view showing states of the display surface 16a of the LCD 16 and the detection region 17a of the touch panel 17 during the ordinary mode in the MFP 1 according to the second embodiment. It is noted that these states are the same as those during the ordinary mode in the MFP 1 according to the first embodiment, which have been described with reference to FIG. 2A, and accordingly will not be described.

FIG. 4B is a view showing an example of the consecutive-mode view displayed on the display surface 16a of the LCD 16 during the consecutive mode in the MFP 1 according to the second embodiment. This example of the consecutive-mode view is what is displayed on the display surface 16a during the consecutive mode in a case where the MFP 1 has been placed from the ordinary mode to the consecutive mode as a result of a consecutive operation made on one of the operation buttons 34 in which the plus-button image element 32a had been positioned.

In the consecutive-mode view in the MFP 1 according to the first embodiment, one of the button image elements 32 representing one of the procedures with which the consecutively-operated operation button 34a is associated is displayed in enlargement. On the other hand, in the consecutive-mode view in the MFP 1 according to the second embodiment, the other button image elements 32 representing the other procedures with which the consecutively-operated operation button 34a is not associated are displayed in enlargement. For example, in the example shown in FIG. 4B, the plus-button image element 32a representing the procedure with which the consecutively-operated operation button 34a is associated is not displayed while the other button image elements 32 such as the minus-button image element 32b and the print-button image elements 32c are displayed in enlargement. However, as in the first embodiment, when the detection region 17a is operated during the consecutive mode, the procedure with which the consecutively-operated operation button 34a is associated is executed no matter which part of the detection region 17a is operated. That is, in the example shown in FIG. 4B, the procedure for increasing the set value of number of copies is executed even when the operation is made on parts of the detection region 17a in which the minus-button image element 32b and the print-button image elements 32c are positioned.

In the MFP 1 according to the second embodiment, the operator can visually recognize, during the consecutive mode, the procedures that are executable by the CPU 10 after termination of the consecutive mode, by seeing the button image elements 32 displayed in enlargement during the consecutive mode.

FIG. 4C is a view showing states of the display surface 16a of the LCD 16 and the detection region 17a of the touch panel 17 upon termination of the consecutive mode in the MFP 1 according to the second embodiment. In the MFP 1 according to the second embodiment, the consecutive-mode view is continued to be displayed even after termination of the consecutive mode, until a next operation is made or until a predetermined length of time elapses from the termination of the consecutive mode. The operation buttons 34, which are associated with the respective procedures, are disposed in respective parts of the detection region 17a of the touch panel 17 in which the respective button image elements 32 representing the respective procedures are positioned. In other words, the operation buttons 34 are disposed in respective positions within the detection region 17a that overlap with the respective button image elements 32 representing the respective procedures with which the operation buttons 34 are associated.

Upon termination of the consecutive mode, there is a high possibility that the operator commands execution of one of the procedures which are other than the procedure that has been consecutively executed. Therefore, as shown in FIG. 4C, each of the operation buttons 34 associated with a corresponding one of the other procedures (other than the consecutively executed procedure) is disposed with its area being increased, thereby facilitating the operator's operation after the consecutive mode.

FIG. 5 is a flow chart showing the display updating routine that is carried out in the MFP 1 of the second embodiment. The display updating routine shown in FIG. 5 is different from the display updating routine (see FIG. 3) in the first embodiment in that steps S502 through S512 are additionally provided between steps S302 and S303 and in that steps S318 though S320 are replaced by step S516. In the following description of the display updating routine of FIG. 5, the same reference signs as used in the description of the display updating routine of FIG. 3 are used to identify the same steps, which will not be described to avoid redundancy of the description.

In the display updating routine of the second embodiment, step S315 is implemented after the MFP 1 is switched from the ordinary mode to the consecutive mode. In this step S315, what is displayed by the CPU 10 is the above-described consecutive-mode view as shown in FIG. 4B.

Further, in the display updating routine of the second embodiment, when a negative judgment (NO) is obtained in step S316, namely, when the detection region 17a is not touched before a timeout during the consecutive mode, the CPU 10 terminates the consecutive mode. In this instance, however, the MFP 1 is not immediately switched to the ordinary mode, and step S516 is implemented whereby the operation buttons 34 are disposed in respective positions within the detection region 17a that overlap with the respective button image elements 32 representing the respective procedures with which the operation buttons 34 are associated. For example, in the example shown in FIG. 4C, the operation button 34 associated with the procedure for reducing the set value of the number of copies by “1” is disposed in a part of the detection region 17a which overlaps with the minus-button image element 32b, while the operation button 34 associated with the procedure for executing a printing operation is disposed in a part of the detection region 17a which overlaps with the print-button image element 32c.

After implementation of step S516, the control flow goes back to step S502 in which the CPU 10 judges whether the consecutive-mode flag 12a is ON or not. For a while shortly after termination of the consecutive mode, a positive judgment (YES) is obtained in step S502 whereby step S504 is implemented. In step S504, the CPU 10 judges whether an ordinary-mode returning condition is satisfied or not. In the present embodiment, the ordinary-mode returning condition is that at least a predetermined length of time has elapsed from the termination of the consecutive mode, or is that a touch made on any one of the operation buttons 34 has been detected after the termination of the consecutive mode.

When a negative decision (NO) is obtained in step S504, the control flow goes back to step S502 so that step S502 is repeatedly implemented by the CPU 10 as long as the negative decision (NO) is obtained in step S504. On the other hand, when a positive decision (YES) is obtained in step S504, step S506 is implemented so that the CPU 10 judges whether the ordinary-mode returning condition has been satisfied by detection of a touch made on any one of the operation buttons 34. When the ordinary-mode returning condition has been satisfied by lapse of at least the predetermined length of time from the termination of the consecutive mode, a negative decision (NO) is obtained in step S506. When the negative decision (NO) is obtained in step S506, the control flow goes back to step S301 so that the CPU 10 places the MFP 1 into the ordinary mode. Then, in step S302, the CPU 10 causes the ordinary-mode view (see FIG. 4A) to be displayed on the display surface 16a of the LCD 16. As in the first embodiment, during the ordinary mode, the operation buttons 34 are disposed in respective parts of the detection region 17a which overlap with the respective button image elements 32 included in the ordinary-mode view.

On the other hand, when a positive judgment (YES) is obtained in step S506, namely, when the ordinary-mode returning condition has been satisfied by detection of a touch made on any one of the operation buttons 34, the control flow goes to step S508 in which the CPU 10 executes one of the procedures with which the touched one of the operation buttons 34 is associated. Then, the CPU 10 places the MFP 1 into the ordinary mode by turning the consecutive-mode flag 12a OFF in step S510, and the CPU 10 causes the ordinary-mode view (see FIG. 4A) to be displayed on the display surface 16a in step S512. After implementation of step S512, the control flow goes to step S306. As in the first embodiment, during the ordinary mode, the operation buttons 34 are disposed in respective parts of the detection region 17a which overlap with the respective button image elements 32 included in the ordinary-mode view. It is noted that, when a negative decision (NO) is obtained in step S502, the control flow goes to step S303.

In the above-described first and second embodiments, the MFP 1 corresponds to an example of an input device; the consecutive-operation-button register memory 14a corresponds to an example of a register; the LCD 16 corresponds to an example of a display; each operation button 34 corresponds to an example of an operation receiving region; the consecutively-operated operation button 34a corresponds to an example of a consecutively-operated operation receiving region; and the set value of number of copies corresponds to a value that is to be changed in accordance with a number of times at which the consecutively-operated operation receiving region is operated. Further, in the first and second embodiments, portions of the CPU 10 which are assigned to implement steps S304 and S311 correspond to an example of an executer; a portion of the CPU 10 which is assigned to implement step S314 corresponds to an operable region expander; portions of the CPU 10 which are assigned to implement steps S302, S319 and S512 correspond to an example of a display controller and an example of an ordinary-display controlling portion; and a portion of the CPU 10 which is assigned to implement step S315 corresponds to an example of the display controller and an example of an extraordinary-display controlling portion.

While the presently preferred embodiments of the invention have been described above in detail, it is to be understood that the invention is not limited to the details of the illustrated embodiments, but may be otherwise embodied without departing from the spirit of the invention.

For example, in the above-described embodiments, the touch panel 17 is a projection-type electrostatic capacitance touch-panel and is capable of detecting either approximation or contact of the input medium with the detection region 17a. However, the touch panel 17 may be configured to detect only contact of the input medium with the detection region 17a. Further, the touch panel 17 may be configured to detect approximation or contact of the input medium with the detection region 17a by means of infrared ray or electric field.

Further, in the above-described embodiments, during the consecutive mode, the entirety of the detection region 17a of the touch panel 17 is caused to be associated with one of the procedures with which the consecutively-operated operation button 34a is originally associated. However, this is not essential but may be suitably modified. That is, during the consecutive mode, as long as at least a part of the detection region 17a is caused to be additionally associated with the one of the procedures with which the consecutively-operated operation button 34a is originally associated, the other part of the detection region 17a may be caused or kept associated with the other of the procedures. Further, during the consecutive mode, while at least one of the operation buttons 34 that are other than the consecutively-operated operation button 34a is caused to be additionally associated with the one of the procedures with which the consecutively-operated operation button 34a is originally associated, the other of the operation buttons 34 may be caused to constitute an operation non-receiving region or regions that are configured not to receive any operation. In either of these modifications, the additionally associated region is additionally associated with one of the procedures with which the consecutively-operated operation button 34a is originally associated, preferably, such that a sum of region of the consecutively-operated operation button 34a and the additionally associated region becomes larger than region of any one of the other operation buttons 34. This arrangement is effective for avoiding the operator from committing an operational error, even if a consecutive operation is made without the operator closely watching an operated position.

Further, in the above-described embodiments, the “operation in a consecutive manner” is an intermittent operation in which the detection region 17a of the touch panel 17 is touched a plurality of times with a time interval between each two successive touches being not longer than a predetermined length of time. However, the “operation in a consecutive manner” may be a continuous operation in which the detection region 17a is long-pressed, namely, touched without interruption for at least a predetermined length of time. That is, the “operation in a consecutive manner” may be either an intermittent operation or a continuous operation, as long as the operation serves to input command for commanding one of the procedures to be repeatedly executed.

Further, each of the operation buttons 34 may be associated with any one of procedures, which are executable in the MFP1, such as a procedure for performing copy or facsimile function, a procedure for increasing or reducing a set value and a procedure for validating a selected one of a plurality of options.

In the above-described embodiments, during the consecutive mode, each of the button image elements 32 are displayed in an extraordinary manner, for thereby facilitating the operator to visually recognize that the MFP 1 is in the consecutive mode. However, a sound effect, which is to be generated upon touch of the touch panel 17 by the operator, may vary depending on whether the MFP 1 is in the ordinary mode or the consecutive mode, so that the operator can acoustically recognize that the MFP 1 is in the ordinary mode or the consecutive mode.

In the above-described embodiments, at least one of the button image elements 32 is enlarged to a predetermined size when the MFP 1 is switched from the ordinary mode to the consecutive mode. However, a size of at least one of the button image elements 32 may be gradually enlarged with increase of the number of times at which the touch panel 17 has been touched or operated during the consecutive mode, so that the operator can visually recognize the number of operation times.

In the above-described second embodiment, the button image element 32 representing the procedure with which the consecutively-operated operation button 34a is associated is not displayed during the consecutive mode. However, this button image element 32 may be displayed during the consecutive mode.

Further, in the above-described second embodiment, during the consecutive mode, the plurality of button image elements 32 representing the other procedures with which the consecutively-operated operation button 34a is not associated are displayed in enlargement. In this second embodiment, one of the button image elements 32 representing a procedure opposite to the procedure with which the consecutively-operated operation button 34a is associated, may be displayed in a size that is sill larger than the other button image elements 32. The opposite procedure may be, for example, a procedure for reducing a set value when the consecutively-operated operation button 34a is associated with a procedure for increasing the same set value. This modified arrangement is significant because there are many cases in which, as a result of consecutive change of a set value in a certain direction, the set value has been changed by a degree larger than a desired degree, thereby requiring the set value to be changed in the opposite direction.

What is claimed is:

1. An input device comprising:
a touch panel having a detection region and configured, when an operation is made within said detection region, to detect a position in which the operation is made, said detection region including a plurality of operation receiving regions which are located in respective positions different from each other and which are associated with respective procedures different from each other;
an executer configured, when one of said operation receiving regions is operated, to execute one of the procedures with which said one of said operation receiving regions is associated; and
an operable region expander configured, when the operated one of said operation receiving regions is operated in a consecutive manner, to cause an additionally associated region to be additionally associated with said one of the procedures with which said operated one of said operation receiving regions is associated, said additionally associated region being included in said detection region and constituting at least a part of rest of said detection region, said rest of said detection region being other than a consecutively-operated operation receiving region that is said operated one of said operation receiving regions.

2. The input device according to claim 1,
wherein said detection region of said touch panel includes, in addition to said operation receiving regions, an operation non-receiving region that is located between said consecutively-operated operation receiving region and at least one of the other of said operation receiving regions,
and wherein said operable region expander is configured to cause at least a part of said operation non-receiving region as at least a part of said additionally associated region, to be additionally associated with said one of the procedures with which said consecutively-operated operation receiving region is associated.

3. The input device according to claim 1, wherein said operable region expander is configured to cause at least one of the other of said operation receiving regions as at least a part of said additionally associated region, to be additionally associated with said one of the procedures with which said consecutively-operated operation receiving region is associated.

4. The input device according to claim 1, wherein said operable region expander is configured to cause said additionally associated region to be additionally associated with said one of the procedures with which said consecutively-operated operation receiving region is associated, such that a sum of said consecutively-operated operation receiving region and said additionally associated region is larger than any one of the other of said operation receiving regions.

5. The input device according to claim 1, wherein said operable region expander is configured to cause an entirety of said detection region of said touch panel, to be associated with said one of the procedures with which said consecutively-operated operation receiving region is associated.

6. The input device according to claim 1, comprising a display controller configured to cause an image to be displayed on a display surface on which said touch panel is superposed,
wherein said display controller includes:
an ordinary-display controlling portion configured to cause button image elements representing the respective procedures, to be displayed in an ordinary manner, such that the displayed button image elements are positioned in said operation receiving regions, respectively, which are associated with the respective procedures; and
an extraordinary-display controlling portion configured, while said additionally associated region is being caused by said operable region expander to be additionally associated with said one of the procedures, to cause at least one of said button image elements to be displayed in an extraordinary manner that is different from said ordinary manner.

7. The input device according to claim 6, wherein, when at least a part of said detection region of said touch panel is operated with said additionally associated region being caused by said operable region expander to be additionally associated with said one of the procedures, said executer is configured to execute said one of the procedures with which said consecutively-operated operation receiving region is associated, irrespective of which one of the procedures is represented by one of said button image elements that is positioned in the operated part of said detection region.

8. The input device according to claim 6, wherein, when said one of the procedures with which said consecutively-operated operation receiving region is associated is a procedure for changing a value in accordance with a number of times at which said consecutively-operated operation receiving region is operated, said extraordinary-display controlling portion is configured to display the changed value.

9. The input device according to claim 6, wherein said extraordinary-display controlling portion is configured to cause one of said button image elements representing said one of the procedures with which said consecutively-operated operation receiving region is associated, to be displayed in enlargement.

10. The input device according to claim 6, wherein said extraordinary-display controlling portion is configured to cause at least one of said button image elements that is other than one of said button image elements representing said one of the procedures with which said consecutively-operated operation receiving region is associated, to be displayed in enlargement.

11. The input device according to claim 1, comprising a register configured to register therein at least one of said operation receiving regions,
wherein said operable region expander is configured, when said consecutively-operated operation receiving region is included in said at least one of said operation receiving regions registered in said register, to cause said additionally associated region to be additionally associated with said one of the procedures with which said consecutively-operated operation receiving region is associated.

12. A recording medium storing an input control program that is to be executed in the input device that is defined in claim 1,
said input control program comprising:
an executing step implemented, when one of said operation receiving regions is operated, for executing one of the procedures with which said one of said operation receiving regions is associated; and
an operable-region expanding step implemented, when the operated one of said operation receiving regions is operated in a consecutive manner, for causing an additionally associated region to be additionally associated with said one of the procedures with which said operated one of said operation receiving regions is associated, said additionally associated region being included in said detection region and constituting at least a part of rest of said detection region, said rest of said detection region being other than a consecutively-operated operation receiving region that is said operated one of said operation receiving regions.
